(19) United States
(12) Patent Application Publication
(10) Pub. No.: US 2015/0197342 A1
(43) Pub. Date: Jul. 16, 2015

(54) COMPOSITE STRAP FOR CONNECTION BETWEEN TWO PARTS

(71) Applicant: AIRCELLE, Gonfreville L'orcher (FR)

(72) Inventor: Loïc LE BOULICAUT, Le Havre (FR)

(21) Appl. No.: 14/609,739

(22) Filed: Jan. 30, 2015

Related U.S. Application Data
(63) Continuation of application No. PCT/FR2013/051808, filed on Jul. 26, 2013.

(30) Foreign Application Priority Data
Aug. 7, 2012 (FR) 12/57651

(51) Int. Cl. B64D 29/06

(52) U.S. Cl. CPC B64D 29/06

(57) ABSTRACT

A composite clevis connecting two parts includes composite clevis plies, an orifice to connect the two parts, and a ring defining the orifice. In particular, the composite clevis plies define a contour of the composite clevis, surround the ring and further define ribs connecting the ring to the contour of the composite clevis.

### CROSS-REFERENCE TO RELATED APPLICATIONS

This application is a continuation of International Application No. PCT/FR2013/051808, filed on Jul. 26, 2013, which claims the benefit of FR 12/57651, filed on Aug. 7, 2012. The disclosures of the above applications are incorporated herein by reference.

### FIELD

The present disclosure relates to a composite clevis allowing the connection between two parts.

### BACKGROUND

The statements in this section merely provide background information related to the present disclosure and may not constitute prior art.

A clevis within the meaning of the present disclosure is an element integral with a first part, provided with an orifice allowing the fastening of a second part.

In the field of aircraft engine nacelles for example, we find such clevises on thrust-reverser beams, to which the sliding cowls are hinged.

In this same field of nacelles, we also find such clevises on thrust reverser flaps, to which rods of actuation of these flaps are connected.

In the field of nacelles, we generally find such clevises on the brackets of the sliding cowls, to which cylinders of actuation of the thrust reverser are connected.

In the field of nacelles, we also find clevises on the brackets of the fixed portion, to which cylinders of actuation of the thrust reverser are connected.

Each of the mentioned above applications have different mechanical & geometrical constraints described hereinafter.

Obviously, this application list is not exhaustive and is not limited to the nacelles.

In an approach of weight reduction of such a nacelle, it is required to make these clevises from composite materials, that is to say, typically from plies (that is to say fabrics) of fibers particularly of glass or carbon, taken from polymerized resin (polyamide for example).

The type of composite fiber (unidirectional fabrics or 2D, 3D weaving/braiding, or any other type) or the method of production (RTM, LRI, pre-impregnated or other composite fibers can be used) does not matter.

These materials offer great design flexibility, by the fact that the plies can be disposed in an optimal manner with regard to involved forces.

This optimization allows minimizing the mass of the clevis for given forces.

### SUMMARY

The present disclosure provides a composite clevis which, for a given resistance, is even less heavy.

In particular, the present disclosure provides a composite clevis for connection between two parts, comprising composite clevis plies and an orifice allowing said connection, remarkable in that it comprises a ring defining said orifice, and in that said composite clevis plies allow defining the contour of said clevis, surrounding said ring and defining ribs connecting said ring to said contour of said clevis.

In the context of the present disclosure, a ring is a block of material allowing the connection between the two parts.

Thanks to the features of the present disclosure, the ring allows distributing the main forces transmitted between the two parts on the entire surface of the portion of the clevis plies which wraps the ring and which is normal to the direction of these forces: this allows attenuating these forces in these clevis plies in the manner of a pressure load.

On the other hand, the portions of clevis plies which define the ribs work essentially in traction/compression, that is to say in their best conditions of resistance, as opposed to work in shear.

According to other features of the present disclosure:

said ring is formed of a material selected from the group comprising a metal alloy or a composite material;

said ring is formed by machining a solid part wrapped by said clevis plies;

said ring exhibits a section, the outer and inner contours of which are selected from the group comprising circles, ellipses, polygons;

said ring exhibits extensions sandwiched between at least some of said clevis plies;
stitches/tufting or any type of known 3D reinforcement connecting together said clevis plies as closely as possible to the ring (example: the ply 29a with 29b in FIG. 8);

the ring is of composite material; and

the stitches/tufting or any type of known 3D reinforcement connecting together said clevis plies and said ring.

The present disclosure also relates to a part equipped with a clevis in accordance with the foregoing, in which at least some of said clevis plies connect said ring to the rest of the part.

According to other features of this part according to the present disclosure:

structuring plies integral with the rest of said part wrap said ring and are covered at least partly with at least some of said clevis plies;

clusters of resin are interposed between said structuring plies and said clevis plies, in the vicinity of said ring;

stitches connecting together said structuring plies and said clevis plies.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a composite thrust-reverser beam, comprising on the one hand conventional hinges, and on the other hand a hinge in accordance with the present disclosure;

FIG. 2A is a perspective view of the hinge in accordance with the present disclosure of FIG. 1;

FIG. 2B is a front view of the area II of FIG. 2A;

FIG. 3 is a cross-sectional view along the plane III-III in FIG. 2B of a plurality of hinges according to the present disclosure which are being placed on a part such as a thrust-reverser beam of FIG. 1;

FIG. 4 is a perspective view of a thrust reverser bracket equipped with clevises according to the present disclosure, and of its immediate environment;

FIG. 5 is a detailed view of the area V of FIG. 4;

FIG. 6 is a cross-sectional view of the ring of the clevis of FIGS. 4 and 5, and of its immediate environment;

FIGS. 7 to 10 are views similar to that of FIG. 6, of other form of clevises according to the present disclosure;

FIG. 11 is a perspective view of an elongate part such as a rod incorporating a clevis according to the present disclosure; and

FIGS. 12 and 13 are cross-sectional views of the area XII of FIG. 11, for two different forms.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In some of the following figures, a reference frame X, Y and Z is shown, which respectively indicates the longitudinal, transverse and vertical directions attached to a nacelle and to its thrust reverser when placed on an aircraft.

More precisely, the arrow of the X-axis points towards the front of the thrust reverser, and the arrow of the Z-axis points towards the top of this thrust reverser.

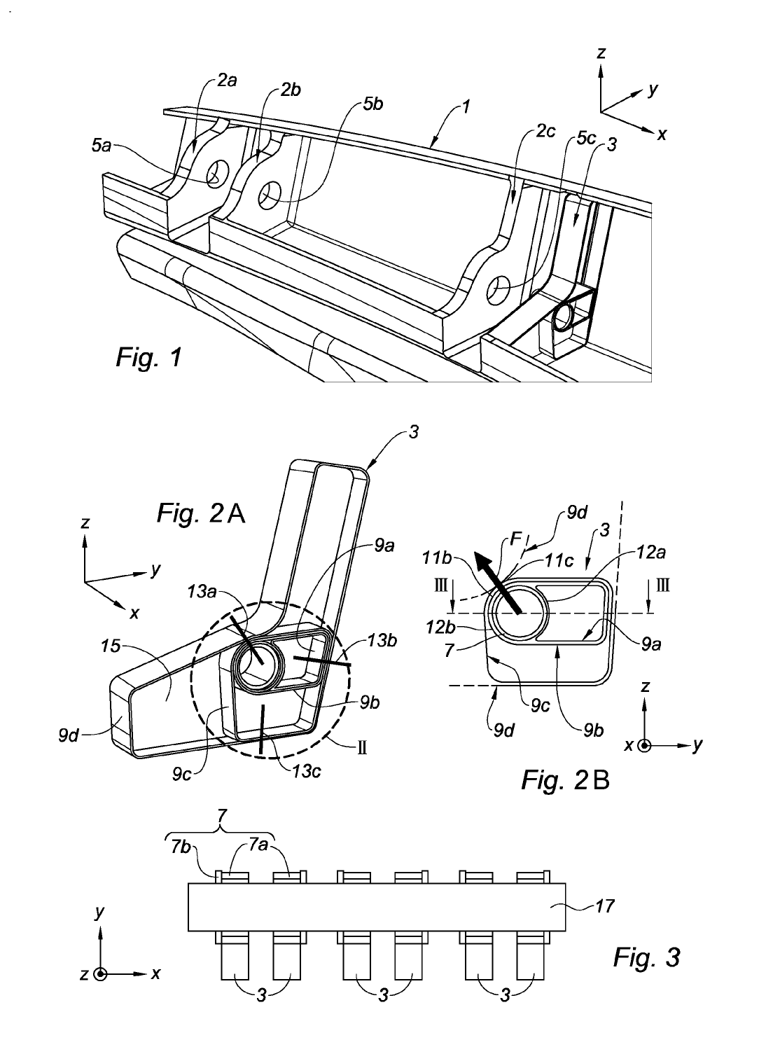

Referring now to FIG. 1, in which an upper beam of the thrust reverser 1 is shown.

Such a beam, also called “12 o'clock” beam by reference to its uppermost position relative to the thrust reverser, allows the installation of the thrust reverser under the wing of the aircraft by means of pins attached on the one hand on a mast of the wing (part for connection between the wing & the nacelle) and on the other hand on the thrust reverser (not shown).

Each half thrust-reverser is hinged by this beam 1 on the mast of the aircraft thanks to a plurality of clevises 2a, 2b, 2c, 3.

As previously indicated, in the context of the present disclosure, the term “clevis” means an element integral with a first part (in this case the “12 o'clock” beam 1) provided with an orifice allowing the fastening of a second part (in this case the mast of the aircraft).

In FIG. 1, the clevises 2a, 2b, 2c are of a conventional design, that is, they each consist of a web of composite material provided with an orifice 5a, 5b, 5c allowing the passage of an hinge pin of the associated thrust reverser half-cowl.

The clevises 2a, 2b, 2c and the “12 o'clock” beam 1 can be formed of composite material, thanks to resin infusion methods, such as the RTM (Resin Transfer Moulding) method.

As indicated in the preamble of the present description, the present disclosure in particular provides clevises that, for a same resistance with regard to the forces imposed by the hinge pin of the associated thrust reverser half-cowl, exhibit a lower mass.

A clevis with a design in accordance with the present disclosure, carrying the reference 3, can be seen in particular in FIGS. 2A and 2B.

The orifice of such a clevis 3 is defined by a ring 7 which can be formed of composite material, metal alloy, or a combination of these two materials.

In the latter case, the ring 7 can be formed of an outer portion 7a of composite material integral with the remainder of the clevis 3, and of a removable inner portion 7b formed of a metal alloy (see FIG. 3).

As can be seen in particular in FIG. 2B, the ring 7 is surrounded by a plurality of composite plies 9a, 9b, 9c, 9d.

The ply 9a encircles the ring 7 over substantially half its periphery.

The plies 9b and 9c wrap the ring 7 in respective areas 11b and 11c which are substantially normal, that is to say perpendicular to the direction of the major forces F transmitted by the half-cowl of the thrust reverser to the “12 o'clock” beam 1.

The three composite belts 9a, 9b, 9c are moreover assembled on the outer structure 9d also made in composite, defining the general contour of the clevis 3.

The belts 9a and 9b include respective areas 12a and 12b which are substantially parallel to the direction of the forces F.

Connections of the stitches types 13a, 13b, 13c for reinforcing the connections between the belts 9a, 9b, 9c, 9d and/or with the ring 7, can be considered.

A composite web 15, extending inside the entire clevis 3, can also be considered if there is a mechanical or a sealing requirement for example.

In the case where this ring 7 is made at least partly in composite, it can be obtained from one-dimensional, two-dimensional or three-dimensional glass or carbon fiber plies, for example, optionally stitched to each other.

This stitch, the same as those 13a, 13b, 13c allowing to connect the different belts 9 and the ring 7 together, can be stitches of the conventional type, or tufting consisting of passing loops of fiber in the thickness of the different plies, then of taking these loops in the resin during polymerization (making these connections preferably close to the spokes).

The shape of the ring as well as the direction of the ribs of FIGS. 1 to 3 could have a geometry as described in FIGS. 6 to 10 for a better mechanical strength.

FIG. 3 schematically illustrates an advantageous form of a part incorporating several clevises 3 according to the present disclosure: it can for example be a part such as the “12 o'clock” beam 1 of FIG. 1, comprising several clevises 3, the orifices of which defined by the rings 7 must be aligned.

As can be seen in FIG. 3, during the polymerization of the resin by curing, a slightly expandable core 17 is disposed on the entire orifice of the rings 7 so as to maintain these orifices coaxial.

As an illustrative but non-limiting example, the core 17 can be formed of carbon.

This method, which allows aligning the pins of the rings of all the clevises, allows obtaining an excellent mounting precision of the half-cowl of the thrust reverser via the “12 o'clock” beam 1.

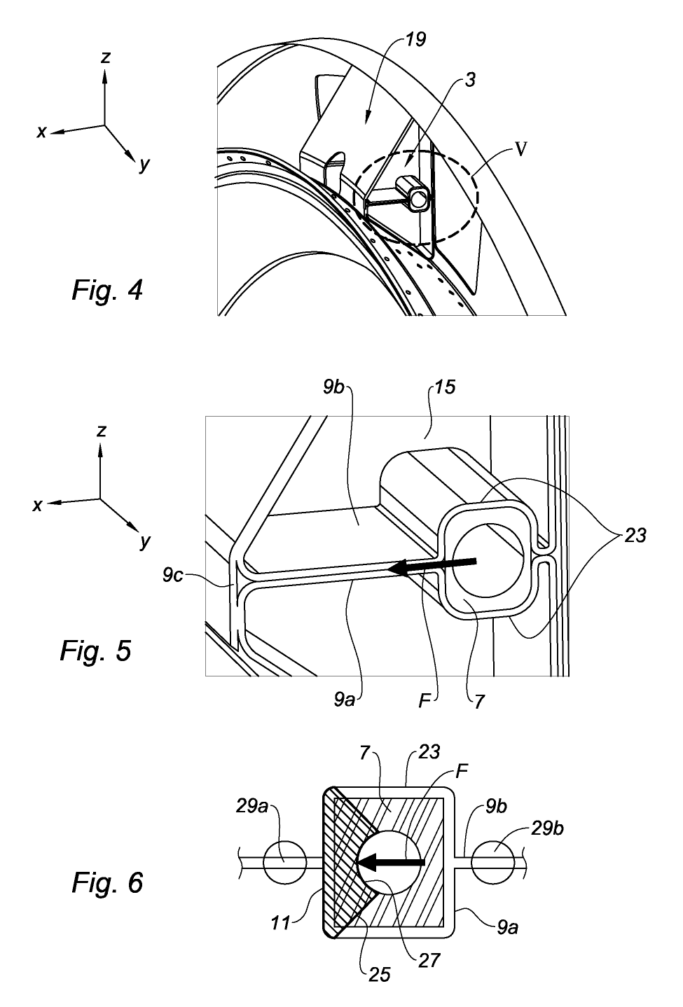

In FIGS. 4 to 6, a bracket 19 of thrust reverser is shown.

Such a bracket allows the connection of the cylinders of actuation of the thrust reverser with the sliding portion of this thrust reverser, so as to pass this thrust reverser between its “direct jet” (normal operation of the aircraft) and “indirect jet” (braking situation of the aircraft on landing) positions.

The bracket 19 incorporates two clevises 3 according to the present disclosure, only one of them can be seen in FIGS. 4 and 5.

This clevis, which is made of composite material, may comprise two inner belts 9a, 9b defining a substantially rectangular section portion 23 inside which is inserted a ring 7 of corresponding outer shape, as well as an outer belt 9c.

The ring 7 can be formed for example of a metal alloy.

As the clevis 3 of FIG. 2A, a web 15 may extend between the different belts 9a, 9b, 9c if there is a mechanical or a sealing requirement as in the cited example.

The main direction of the forces to which the bracket 19 is subjected is indicated by the arrow F in FIG. 5.

As can be seen in FIG. 6, the belts 9a and 9b define an area 11 wrapping the ring 7, which is substantially parallel to the direction of the forces F.

By examining FIG. 6 in which the hatching 25 shows the area of transmission of the forces F from the inside of the ring 7 to the periphery thereof, it can be seen that this transmission is done in the manner of a pressure field.

More specifically, the surface of the area 11 substantially normal to the direction of the forces F being much greater than the surface of application 27 of these forces F inside the ring 7, this results in an attenuation of the forces transmitted to the composite plies that are in the area 11.

As shown in FIG. 6, the forces F allow moreover the ribs 29a, 29b defined by the adjacent areas of the belts 9a and 9b surrounding the ring 7 to work in compression/traction, which ribs extend in a direction substantially parallel to that of the forces F.

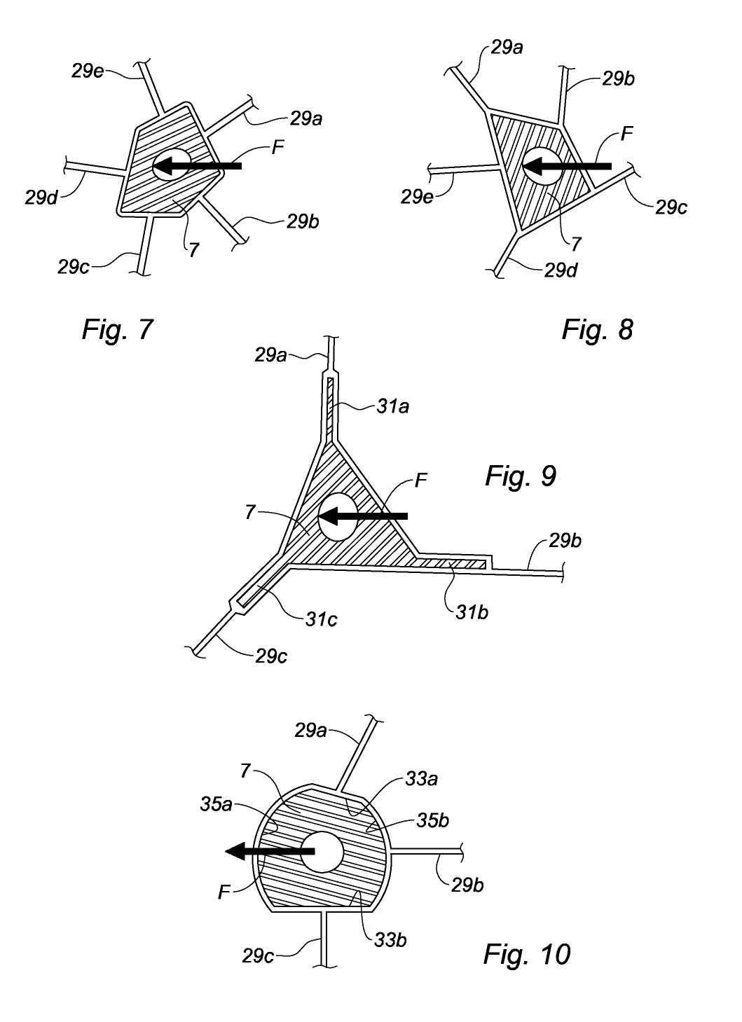

In FIGS. 7 and 8, a generalization of the form of FIGS. 4 to 6 is shown.

In the form shown in FIG. 7, the ring 7 has a polygonal outer contour, and the ribs 29a to 29e defined by the junction of the belts of adjacent composite plies reach each substantially the middle of the respective sides of the polygon defined by the outer contour of the ring 7.

In the form of FIG. 8, some of these ribs 29a, 29b, 29c, 29d reach the vertex of the polygon defined by the outer contour of the ring 7.

It will be noted that the section of the inner orifice of the ring 7 can be circular as has been described so far.

The advantage of a planar shape outside the ring 7 with respect to a circular shape is that it allows avoiding the distance and thus the delamination of the plies 29a relative to 29b, the plies 29b relative to 29c, etc.

However, this shape is non-restrictive. Other shapes might be suitable, such as an elliptic shape, a rectangular shape, etc.

In the form shown in FIG. 9, the ring 7 includes extensions 31a, 31b, 31c which are sandwiched in the composite plies defining the ribs 29a, 29b and 29c disposed around this ring.

In the form shown in FIG. 10, we can see that the ring 7 can exhibit any outer contour other than a polygonal one, and in particular a contour comprising rectilinear portions 33a, 33b, and curves 35a, 35b.

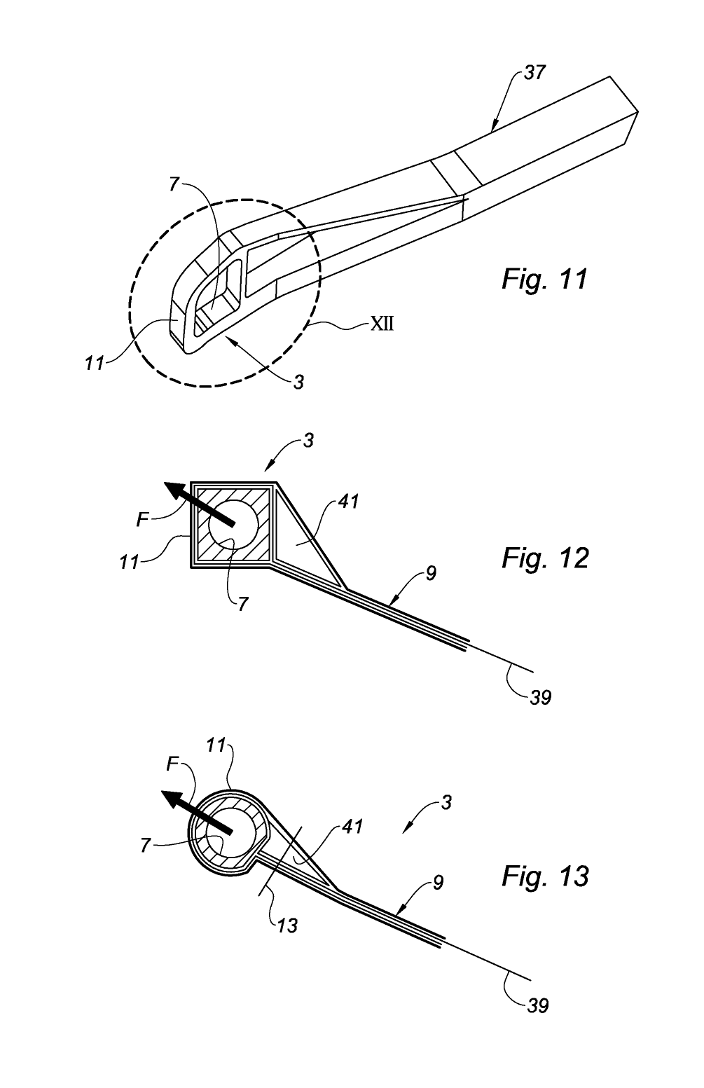

Referring now to FIGS. 11 to 13, in which an elongate part 37 incorporating a clevis 3 according to the present disclosure is shown.

Such a part can for example be a rod of actuation of the thrust reverser flap, or any other rod involved in constituting a nacelle for an aircraft engine.

It can also be a junction of rear frame of cascades which allows maintaining the back of the cascades of a thrust reverser on the 12 o'clock & 6 o'clock beams.

It can also be a local extension on a mast or arm. The geometry of the plies doesn't surround either a polygonal ring but a polygonal mast, according to the present disclosure or substantially cylindrical in which case an intermediate polygonal ring according to the present disclosure will be necessary (example of possible configuration, see figure below).

In the form shown in FIG. 12, we can see that the ring 7 exhibits an outer contour of a substantially squared shape, and an inner contour of substantially circular shape.

This ring 7 is wrapped by a belt 9 of composite material comprising an area 11 substantially perpendicular to the direction of the main forces F to which the clevis 3 is subjected.

More specifically, between the composite belt 9 and the ring 11 lies another composite belt 39, which also wraps this ring 7 and is, at its other end, connected to the structure of the part 37.

For this reason, we can say that the composite belt 39, which is in fact an integral portion of the part 37, is structuring, as opposed to the composite belt 9 which enters only in constituting the clevis 3, and which can be referred to as by ring belt.

For an improved distribution of forces, we can consider placing between the belts 9 and 39, in the proximity of the ring 7, a cluster of composite or foam 41 which avoids cluster of resin, that the one skilled in the art calls “nail head” with reference to the substantially triangular section of this area.

The thus obtained structure can be advantageously reinforced thanks to a traverse connection of the stitching or tufting type 13 (see FIG. 13) crossing the two composite belts 9 and 39 and the nail head 41.

The form of FIG. 13 differs from that of FIG. 12 mainly in the fact that the ring 7 exhibits an outer contour of substantially circular shape and that the diffusion of the forces will avoid delamination by a planar connection between the fibers and the ring 7 as in the examples of FIGS. 6 to 10.

As will be understood in the light of the foregoing description, the present disclosure allows making a composite clevis thanks to which the forces transmitted between the different parts involved are distributed in the manner of a pressure load in the different composite belts which are disposed around the ring.

In addition, the clevis according to the present disclosure allows making these different belts work mainly in traction/compression, that is to say in the best ranges of behavior of these belts, as opposed to shear forces.

The applications of the present disclosure are particularly numerous in the design of the aircraft engine nacelles but they can of course be extended to any related field.

Of course, the present disclosure is not limited to the described and represented forms, provided by way of simple examples.

What is claimed is:

1. A composite clevis for connecting two parts, comprising:
composite clevis plies;
an orifice configured to connect said two parts; and
a ring defining said orifice;
wherein said composite clevis plies define a contour of said composite clevis, surround said ring and define ribs connecting said ring to said contour of said composite clevis.

2. The composite clevis according to claim 1, wherein said ring is formed of a material selected from at least one of a metal alloy and a composite material.

3. The composite clevis according to claim 1, wherein said ring is formed by machining a solid part wrapped by said composite clevis plies.

4. The composite clevis according to claim 1, wherein said ring exhibits a section defined by outer and inner contours thereof, and a shape of the section is selected from at one of circles, ellipses and polygons.

5. The composite clevis according to claim 1, wherein said ring exhibits extensions sandwiched between at least some of said composite clevis plies.

6. The composite clevis according claim 1, wherein said ring is made of composite material, and stitches connect together said composite clevis plies and said ring.

7. A part equipped with a composite clevis according to claim 1, wherein at least some of said composite clevis plies connect said ring to the rest of the part.

8. The part according to claim 7, wherein structuring plies integral with the rest of the part are configured to wrap said ring and are covered at least partly with at least some of said composite clevis plies.

9. The part according to claim 8, wherein areas are filled with a composite material or foam interposed between said structuring plies and said composite clevis plies, in the vicinity of said ring.

10. The part according to claim 8, wherein stitches connect together said structuring plies and said composite clevis plies.
